(19) United States
(12) Patent Application Publication
(10) Pub. No.: US 2007/0061721 A1
(43) Pub. Date: Mar. 15, 2007

(54) System for providing review verifications displayed on a markup language document received at a network display station from sources on the network and for updating such verifications

(76) Inventors: Leugim A. Bustelo, Austin, TX (US); Andrew D. Hately, Austin, TX (US); Julio E. Ruano, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/217,864

(22) Filed: Sep. 1, 2005

(51) Int. Cl. G05B 19/42

(52) U.S. Cl. 715/705; 700/87

(57) ABSTRACT

Providing verifications on a markup language document, from a source on the network, received and displayed at one of said display stations comprising reviewing the markup language document at a display station remote from the receiving display station combined with means responsive to the reviewing means for providing review verifications for the reviewed markup language document. The implementation selectively superimposes a transparent displayed layer over the displayed received markup language document. Then, there are means for indicating the review verifications of the displayed markup language document by non-alphanumeric visual indicators within said transparent displayed layer. The visual indicators may have specific colors.

### CROSS-REFERENCE TO RELATED COPENDING PATENT APPLICATIONS

The following patent application assigned to the assignee of the present invention and filed on Jun. 16, 2005, covers subject matter related to the subject matter of the present invention and is entitled: “A SYSTEM FOR CREATING MARKUP LANGUAGE DOCUMENTS AT A RECEIVING DISPLAY STATION HAVING MULTIPLE CONTENTS FROM MULTIPLE SECURED ON A COMMUNICATION NETWORK, E.G. THE WEB WITH VISUAL INDICATORS FOR IDENTIFYING CONTENT AND SECURITY”, Hately et al., (Attorney Docket No. AUS920050245US1), and copending Patent Application entitled: “A SYSTEM FOR CREATING MARKUP LANGUAGE DOCUMENTS AT A RECEIVING DISPLAY STATION HAVING MULTIPLE CONTENT PORTIONS FROM MULTIPLE SOURCES WITH IMPLEMENTATION FOR DISPLAYING THE STATE OF SETS OF CONTENT REVIEWS TO WHICH CONTENT PORTIONS SUBJECTED” (Attorney Docket No. AUS920050407US1), also assigned to assignee of the present Application and filed contemporaneously herewith.

### TECHNICAL FIELD

The present invention relates to a system, method and program for creating markup language documents, the contents of which are obtained from multiple sources from computer networks, such as the World Wide Web (Web) or Internet.

### BACKGROUND OF THE RELATED ART

The past decade has been marked by a technological revolution driven by the convergence of the data processing industry with the consumer electronics industry. The effect has driven technologies that have been known and available and relatively quiescent over the years. Two of these technologies are the Internet related distribution and object oriented programming systems. Both of these technologies are embodied in the use of object oriented technology and the Java programming system, in particular, for a wide variety of consumer and business purposes over the Internet or Web or like private networks.

With the development and rapid expansion of the Web and other like networks, markup languages became the primary vehicle for distribution of data over such networks. A basic hypertext markup language, HTML, is described in detail in the text entitled Just Java, 2nd Edition, Peter van der Linden, Sun Microsystems, 1997, particularly at Chapter 7, pp. 249-268, dealing with the handling of Web pages; and also in the text, Mastering the Internet, G. H. Cady et al., published by Sybex Inc., Alameda, Calif., 1996, particularly at pp. 637-642, on HTML in the formation of Web pages. The Web pages are implemented so as to be used for the distribution of Web documents containing text, images, both still and moving, and sound, as well as programs.

The rapid expansion of people, businesses and organizations with Web or Internet (used interchangeably) access has resulted in the widespread use of the Web for business, e.g. e-business and like electronic business, educational, medical and legal transactions. The complexity of the interrelationships involved in these transactions has made it common to handle and distribute Web or like private network documents having multiple contents respectively from multiple sources on the network. Such sources may be individual users at network display stations, as well as network databases that provide already developed and stored content. With the greater reliance on the impersonal network communication, there is less personal contact between the contributors of the content of these network documents. This makes it much harder for a participating user in a network transaction to recognize who contributed what to the document. The above cross-referenced copending application, “A SYSTEM FOR CREATING MARKUP LANGUAGE DOCUMENTS AT A RECEIVING DISPLAY STATION HAVING MULTIPLE CONTENTS FROM MULTIPLE SECURED ON A COMMUNICATION NETWORK, E.G., THE WEB WITH VISUAL INDICATORS FOR IDENTIFYING CONTENT AND SECURITY”, Hately et al., (Attorney Docket No. AUS920050245US1) provides an implementation for tracking, storing and displaying via visual indicators, the sources of the various content portions in any markup language document created or rendered from multiple sources.

While this is an effective implementation in tracking Web or like network sources of document content portions, further problems are encountered when the document being created from multiple content sources has content portions that require sets of content reviews. The results of these content reviews are very important to both the host controlling the document sources, as well as to those creating the multiple content portions for the multiple content network document. In today's electronic commerce, for example, in the creation of network documents with content portions from multiple sources, the content portions of the variety of sources may have been subjected to sets of content reviews for many purposes. For example, a business company preparing to ship thousands of a specially designed and manufactured device may be generating a multi-content Web document having sets of reviews including approved legal reviews, approved accounting reviews, approved quality reviews, as well as time stamps and like commitments. Accordingly, in such multiple content portioned network, e.g. Web documents, it is important not only to be enabled to identify the sources of the portions but to be able to present to the user or viewer at a display terminal a user friendly Graphical User Interface (GUI) that shows the status of reviews.

Consequently, “A SYSTEM FOR CREATING MARKUP LANGUAGE DOCUMENTS AT A RECEIVING DISPLAY STATION HAVING MULTIPLE CONTENT PORTIONS FROM MULTIPLE SOURCES WITH IMPLEMENTATION FOR DISPLAYING THE STATE OF SETS OF CONTENT REVIEWS TO WHICH CONTENT PORTIONS SUBJECTED” (Attorney Docket No. AUS920050407US1) provides an implementation for a user at a network display station who is reviewing or developing a network, e.g. Web document, that will easily indicate the status of sets of content reviews to which each content portion has been subjected to in a multiple content portion displayed document. A set of displayable non-alphanumeric visual indicators associated with each content portion, each indicator respectively representing the status of one of said set of content reviews. Then an implementation is provided enabling a user at the receiving display station to sequentially and collectively proceed through said sets of content reviews.

While both of these two copending patent applications provide excellent visual aids for enabling the user of a Web document at a receiving display station to distinguish sources of content and current verification status of required reviews of received displayed Web Documents, we have recognized a need to separate the visual indicator data from the data content of the network, e.g. Web documents, so that verification, e.g. signature and time stamps, may be dynamically updated without intruding upon or entering the content of the network documents themselves.

### SUMMARY OF THE PRESENT INVENTION

The present invention offers an implementation for effectively visually displaying requisite review verifications for content portions of a displayed markup language, e.g. Web document, that verifications may be dynamically modified without altering document content. The invention is applicable to the network, e.g Web documents, of the above-mentioned copending Application wherein the document has content portions from multiple sources, as well as to network documents from single sources.

Accordingly, there is provided a system for providing verifications on a markup language document, from a source on the network, received and displayed at one of said display stations comprising means for reviewing said markup language document at a display station remote from said receiving display station combined with means responsive to said reviewing means for providing review verifications for said reviewed markup language document. The implementation selectively superimposes a transparent displayed layer over said displayed received markup language document. Then there are means for indicating said review verifications of said displayed markup language document by non-alphanumeric visual indicators within said transparent displayed layer. The visual indicators may have specific colors.

Preferably, the system provides for storing the content of said transparent layer independent of the storage of the content of said markup language document whereby the content of said transparent layer may be modified independently of the markup language document content. In this manner, the visual indicators may be readily modified responsive to changes in review verifications with affecting network document content even after the document has been transmitted to a user over the network.

In a preferred embodiment, the network is the Web, and said document is created with XML protocols. Also, the markup language document may include multiple content portions, respectively, from multiple sources on said network and the review verifications are provided from sources on said network independent of said sources of said markup language document. Also, one or more of the review verifications may be a verified electronic signature.

### BRIEF DESCRIPTION OF THE DRAWING

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning both as a server computer and a client display station in the network of the present invention;

FIG. 2 is a generalized diagrammatic view of a network portion, i.e. a server computer connected to a Web portion to illustrate how the present invention provides visual indicators to represent the states of review verifications for the received markup language document;

FIG. 3 is an illustrative interactive display showing an illustrative page of a Web document to illustrate how the present invention provides visual indicators to represent the states of verification reviews for the markup language documents;

FIG. 4 is the interactive display of FIG. 3, it is an illustration showing how the Web document view of FIG. 3 may be separated into its two discrete layers: the underlying document and the overlay containing verification status visual indicators;

FIG. 5 is an illustrative flowchart describing the setting up of the elements of the present invention for the provision of visual indicators to represent the verification reviews for the markup language document; and

FIG. 6 is a flowchart of an illustrative run of the program set up in FIG. 5.

### DETAILED DESCRIPTION OF THE PREFERRED EMBODIMENT

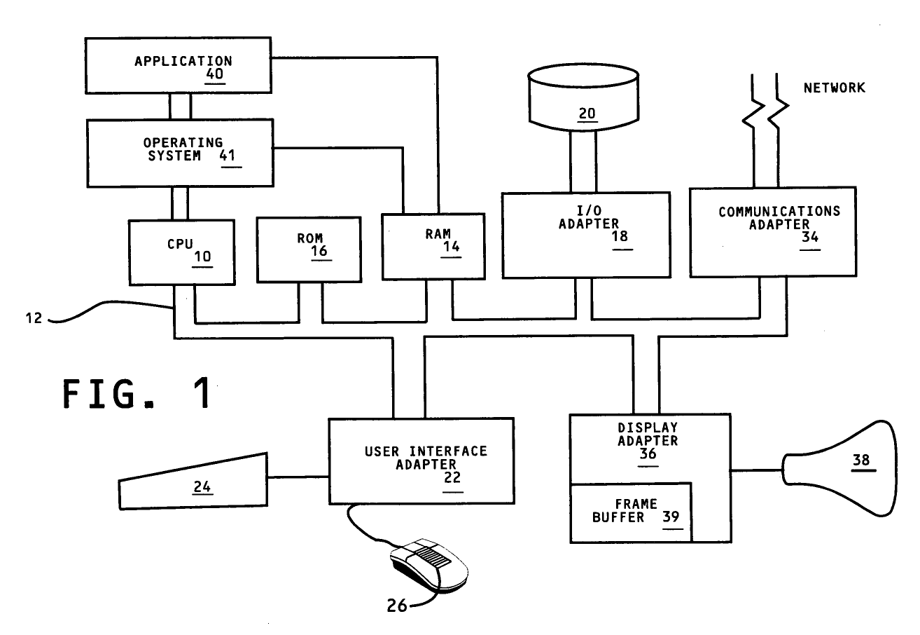

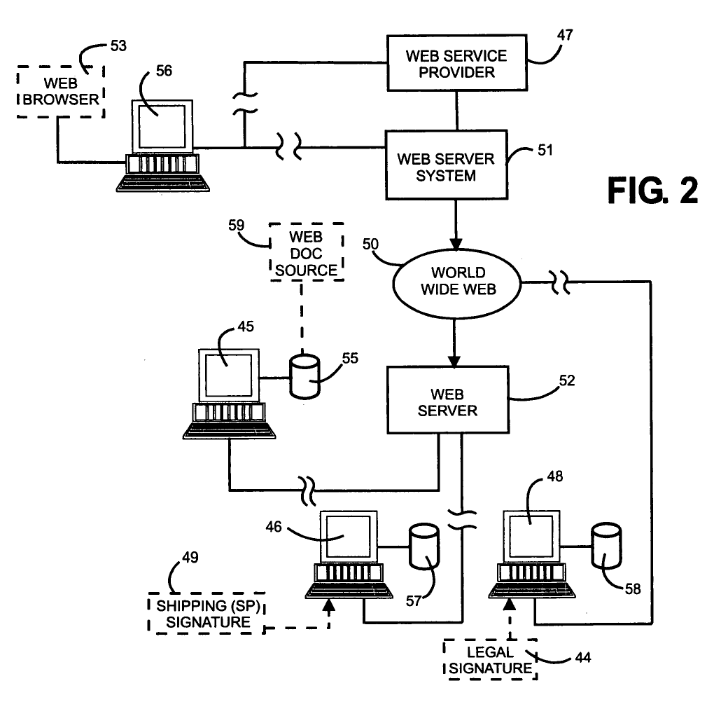

Referring to FIG. 1, a typical data processing unit is shown that may function as the network display stations used for receiving the Web documents from multiple sources on the Web or function as the Web or network server computers for accessing each of the multiple contents from their sources on the Web in the present embodiment wherein the Web is the illustrative network. A central processing unit (CPU) 10, such as one of the PC microprocessors or workstations, available from International Business Machines Corporation (IBM) or Dell PC microprocessors, is provided and interconnected to various other components by system bus 12. An operating system 41 runs on CPU 10, provides control and is used to coordinate the function of the various components of the computer of FIG. 2. Operating system 41 may be one of the commercially available operating systems, such as IBM's AIX or Microsoft's WindowsMe™ or Windows 2000™, as well as UNIX and other IBM AIX operating systems. Application programs 40, controlled by the system, are moved into and out of the main memory Random Access Memory (RAM) 14. These programs include the programs of the present invention for the use of visual indicators in a separable overlayer or template to represent the states of review verifications for the markup language document on the display screens of the receiving Web stations. These functions will be described hereinafter in combination with conventional Web browsers (browsers 53, FIG. 1) at Web display stations 56 (FIG. 1), such as Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network. I/O devices are also connected to system bus 12 via user interface adapter 22 and display adapter 36. Keyboard 24 and mouse 26 are all interconnected to bus 12 through user interface adapter 22. It is through such input devices that the user at the Web display stations may interactively relate to the Web server programs for providing the markup language, e.g. hypertext documents of the present invention wherein color indicators are used to represent the states of review verifications for the markup language documents.

Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

A generalized example of the practice of the present invention wherein color indicators in a separable overlay layer independent of the underlying markup language (e.g. Web) document are used to represent the states of review verifications, accessed from sources on the Web, for statements and other content portions in the markup language document will be considered with respect to FIG. 2. It shows a generalized portion of the Web that serves as the illustrative communication network in this embodiment of the present invention. First, it should be helpful to understand from a more general perspective the various elements and methods that may be related to the present invention. Since the present invention is applicable to Web markup language hypertext documents, formed by multiple content portions, respectively from multiple sources on the Web, an understanding of the Web and its operating principles would be helpful. Reference has also been made to the applicability of the present invention to a global network, such as the Internet or Web. For details on Internet nodes, objects and links, reference is made to the above-referenced text, Mastering the Internet. (Web and Internet are used interchangeably in this description.)

The Internet or Web is a global network of a heterogeneous mix of computer technologies and operating systems. Higher level objects are linked to lower level objects in the hierarchy through a variety of network server computers. These network servers are the key to network distribution, such as the distribution of Web pages and related documentation.

Web documents are conventionally implemented in a markup language, e.g. HTML, which is described in detail in the above-referenced text, Just Java, particularly at Chapter 7, pp. 249-268, dealing with the handling of Web pages; and also in the text, Mastering the Internet, particularly at pp. 637-642, on HTML in the formation of Web pages. In addition, aspects of this description will refer to Web browsers. A general and comprehensive description of browsers may be found in the above-mentioned Mastering the Internet text at pp. 291-313. More detailed browser descriptions may be found in the text, Internet: The Complete Reference, Millennium Edition, M. L. Young et al., Osborne/McGraw-Hill, Berkeley Calif., 1999, Chapter 19, pp. 419-454, on the Netscape Navigator; Chapter 20, pp. 455-494, on the Microsoft Internet Explorer; and Chapter 21, pp. 495-512, covering Lynx, Opera and other browsers.

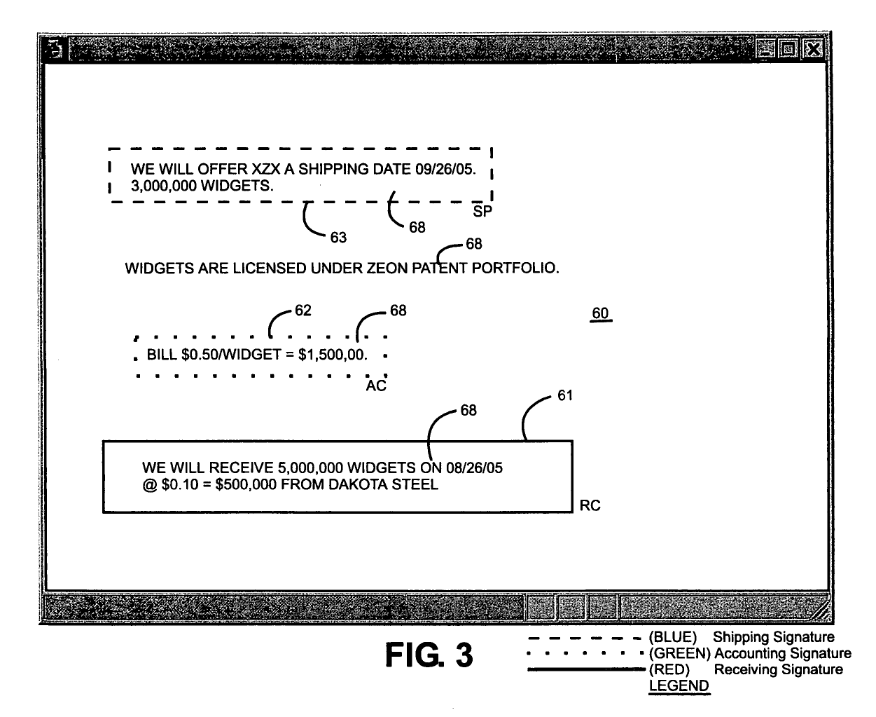

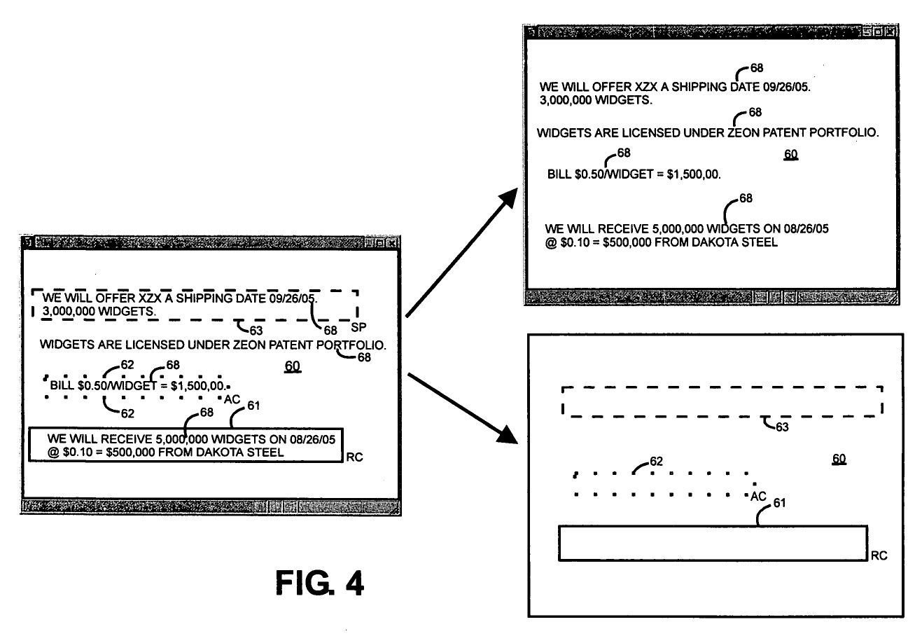

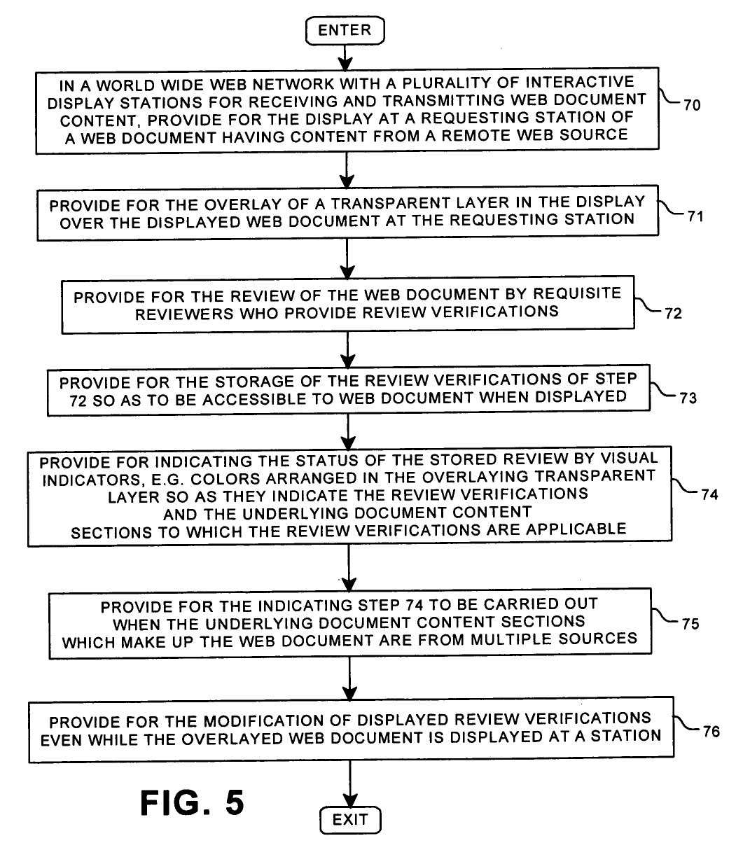

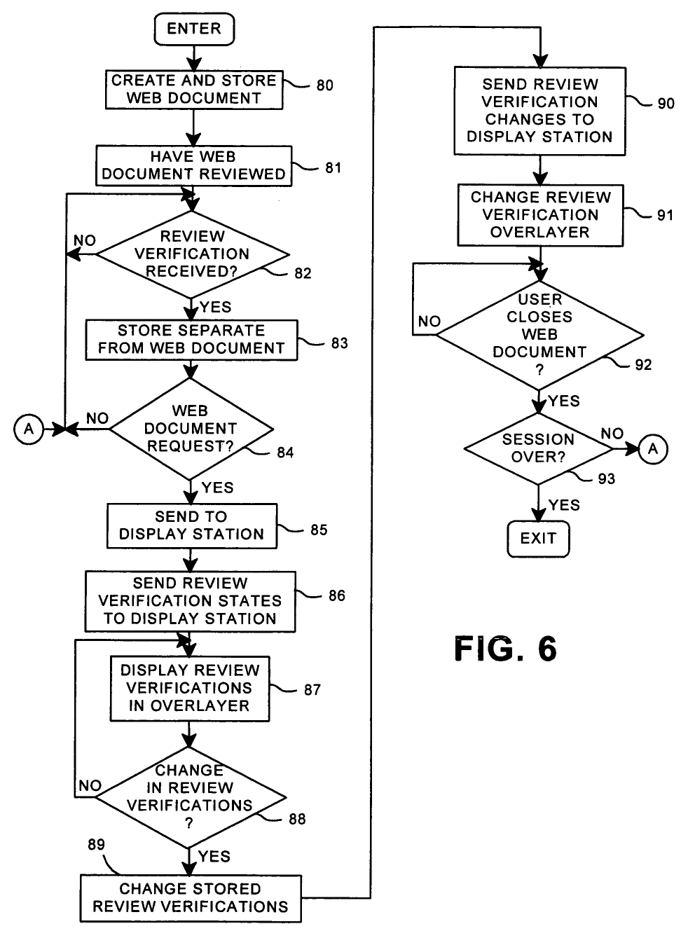

Within this environment, Web Services distribution has evolved in recent years. Web Services are based on both suppliers of the data in the form of XML based messages and documents and applications consuming such data conforming to several industry standards developed by the W3C. The primary standard is XML (Extended Markup Language) for defining data and creating markup languages in the form of XML tags. The resulting XML documents are text based and, thus, may be processed on any platform in the distribution of the Web Services. In light of this background, reference is made to FIG. 2 showing a portion of the Web or Internet set up for the distribution of text based data. Thus, data content in the form of HTML or other XML document portions may be transmitted over the Web and entered into receiving Web documents at receiving Web display stations. For purposes of the present embodiment, let computer station 56, FIG. 2, serve as a typical Web display station for receiving or sending Web documents. As will be described hereinafter with respect to the display interfaces of FIGS. 3 and 4 and the programs of FIGS. 5 and 6, the received Web documents, either having content from a single source or multiple content portions from several sources, are displayed on computer display station 56 and the states of color indicators in the separable overlay layer independent of the underlying markup language (e.g. Web) document are used to represent the review verifications accessed from sources on the Web for statements and other content portions in the markup language document. This will be hereinafter described in greater detail with respect to FIGS. 3 through 8. Under the control of any conventional Web browser 53 in computer 56, the desired Web document is accessed from its source or selected multiple data content-portions from multiple sources are combined into a composite Web document. The portion of the Web shown has four participating Web display stations 56, 45, 46 and 48, with the latter three having associated databases 55, 57 and 58. For purposes of this illustration, we are displaying a Web document from a single source 59 (source station 45) at Web display station 56 under control of Web browser program 53 operating via a conventional Web server system 51, via the Web 50 to any of the multiple content portions from any of databases 55, 57 and 58, respectively, associated with Web display stations 45, 46 and 48 or from input made by users at any of terminals 45, 46 and 48, connected via Web servers, e.g. server 52 to Web 50. The required review verifications, e.g. electronic “signoff” signatures, may come from functions operating throughout the Web, e.g shipping signature 49 output from display station 49 or legal signature output from display station 48.

It will also be understood that instead of any conventional Web server, system 51 may replaced by a server system of a service provider 47 that will conventionally perform this Web server function along with other Web service provider functions.

As will be hereinafter described with respect FIGS. 3 through 6, the invention requires that the review verifications, e.g. electronic signatures, be combined into a transparent overlay layer or template to be superimposed on the displayed Web document. In this manner, the content of the overlay is independent of the Web document content so that the indicators in the overlay may be updated and changed as the status of reviews may change without affecting the Web document content. Thus, the data representing this overlay layer may be initially stored separate from the content of the Web document at the source of the Web document and sent along with the requested Web document. This verification overlayer content may also be stored at the receiving Web document station 56 or at the Web server 51 or Service Provider 47 supporting this receiving station. Such storage of the overlayer in connection with the receiving display station is particularly preferable when the Web document at station 56 is a composite Web document from multiple sources on the Web.

It should be noted that in the dynamic processes of electronic business, when a Web document is received at a receiving station 56, it may not have all of the needed review verifications, e.g. signatures. In such situations, the signature may be readily incorporated into the stored and displayed overlayer without changing the content of the underlying Web document. This would also be the case where there is change in a review verification.

With reference to FIG. 3, the display screen 60, as shown, has a displayed Web document at the stage where the document has been accessed and displayed together with its overlayer from a single source on the Web. For convenience in illustration, a single source document is illustrated. However, it will be understood that the principles of the present invention are equally applicable to multiple source documents as described in the cross-referenced copending Patent Applications.

Content paragraphs 68 provide data relative to a shipment of widgets. This data is in the underlying Web document. The status of the various required review verifications 61-63, i.e. the colored borders, are in a separate overlayer superimposed upon the Web document. These colored borders, each representing a different review verification status as defined in the bottom LEGEND, blue border 63 represents an illustrative shipping department (SP) verification; green border 62 represents an accounting (AC) verification signature; and red border 70 a verification signature (Rc) from the receiving department. It should be noted that the item: “Widgets are licensed under Zeon patent portfolio.” has no color indication of a review verification. Let us assume that a verification is due from the legal department. When such a verification finally arrives, only the overlayer will have to be changed to include an appropriate color indicator to reflect the legal verification.

The “transparent” overlay 67 is diagrammatically shown in FIG. 4 as separated from the underlying Web document 60. It may be conventionally formed and displayed from the stored verification signature data by the text/graphics processor in the receiving display station in the same manner as if there were no Web document present and the display was blank. The only relationship that the text/graphics color indicators 61-63 have to the underlying Web document 60 is the spatial one shown in FIG. 3. This is illustrated in FIG. 4. The initial composite overlay of FIG. 3 is shown separated into the basic Web document 60 of FIG. 3 and transparent overlay 67 containing color indicators 61-63.

Now, with reference to FIGS. 5 and 6 there will be described a process implemented by the present invention in conjunction with the flowcharts of these figures. FIG. 5 is a flowchart showing the development of a process according to the present invention for use of color indicators in a separable overlay layer independent of the underlying markup language (e.g. Web) document to represent the states of review verifications, accessed from sources on the Web, for statements and other content portions in the markup language document.

In a Web network with a plurality of interactive display stations for receiving and transmitting Web document content, provision is made for the display at an appropriate requesting station of a Web document having content contributed from a single or multiple Web sources including databases and other display stations, step 70. Provision is made for the overlay of a transparent layer in the display superimposed over the received Web document, step 71. Provision is made for the review of the Web document by requisite reviewers who provide review verifications, step 72. Provision is made for the storage of the review verifications in step 72 separate and apart from the content of the Web document so as to be accessible to the Web document when the document is displayed, step 73. Provision is made for the indication of the stored review verifications through visual indicators, e.g. colors arranged in the overlaying transparent layer, so as to indicate the review verifications and the underlying document content sections to which the review verification are applicable, step 74. Provision is then made for indicating step 74 to be carried out when the underlying document sections that make up the Web document are from multiple sources, step 75. Provision is made for the modification of displayed review verifications even while the overlaid Web document is displayed at a station, step 76.

An illustrative run of the process set up in FIG. 5 will now be described with respect to FIG. 6. First, step 80, a Web document is created at document source. The document is distributed for review to several reviewers who are required to input appropriate verifications, e.g. signatures, step 81. Then, determinations are made as to whether a requisite verification has been received. If No, verifications are awaited. If Yes, then these verifications are stored as data for an overlay or template, step 83. At this point, a determination may be made as to whether a Web document has been requested, step 84. If No, the process is returned to step 82. If Yes, the requested Web document is sent to the requesting station, step 85, along with the stored states of the required review verifications for the Web document, step 86. These verifications are embodied as color indicators in an over layer, step 87. While the document and its overlay are being used at the requesting station, a determination is made, step 88, as to whether there have been any changes in the document verifications, step 88. If No, the process is returned to step 87. If Yes, the change is effected in the stored reviews, step 89, and these changes are sent to the display station that has the requested Web document, step 90, where the changes are implemented in the overlayer without affecting the Web document, step 91. At this point, a determination is made as to whether the user has closed the requested Web document, step 92. If No, the process is returned to step 92 and use of the document is continued. If Yes, a further determination is made as to whether the session is over, step 93. If Yes, the session is exited. If No, process is returned to step 82 via branch “A”.

Although certain preferred embodiments have been shown and described, it will be understood that many changes and modifications may be made therein without departing from the scope and intent of the appended claims.

What is claimed is:

1. In a communication network with user access via a plurality of data processor controlled interactive network display stations, a system for providing verifications on a markup language document, from a source on the network, received and displayed at one of said display stations comprising:
means for reviewing said markup language document at a display station remote from said receiving display station;
means responsive to said reviewing means for providing review verifications for said reviewed markup language document;
means for selectively superimposing a transparent displayed layer over said displayed received markup language document; and
means for indicating said review verifications of said displayed markup language document by non-alphanumeric visual indicators within said transparent displayed layer.

2. The network system for providing verifications of claim 1 wherein said visual indicators have specific colors.

3. The network system for providing verifications of claim 1 further including means for modifying said visual indicators responsive to changes in said review verifications.

4. The network system for providing verifications of claim 3 further including means for storing the content of said transparent layer independent of the storage of the content of said markup language document whereby the content of said transparent layer may be modified independently of the markup language document content.

5. The network system for providing verifications of claim 4 wherein said network is the World Wide Web, and said document is created with XML protocols.

6. The network system for providing verifications of claim 4 wherein:
said markup language document includes multiple content portions respectively from multiple sources on said network; and
said review verifications are provided from sources on said network independent of said sources of said markup language document.

7. The network system for providing verifications of claim 4 wherein one of said review verifications is a verified electronic signature.

8. In a communication network with user access via a plurality of data processor controlled interactive network display stations, a method for providing verifications on a markup language document, from a source on the network, received and displayed at one of said display stations comprising:
reviewing said markup language document at a display station remote from said receiving display station;
providing review verifications for said reviewed markup language document responsive to said review;
selectively superimposing a transparent displayed layer over said displayed received markup language document; and
indicating said review verifications of said displayed markup language document by non-alphanumeric visual indicators within said transparent displayed layer.

9. The network method for providing verifications of claim 8 wherein said visual indicators have specific colors.

10. The network method for providing verifications of claim 8 further including the step of modifying said visual indicators responsive to changes in said review verifications.

11. The network method for providing verifications of claim 10 further including the step of storing the content of said transparent layer independent of the storage of the content of said markup language document whereby the content of said transparent layer may be modified independently of the markup language document content.

12. The network method for providing verifications of claim 11 wherein said network is the World Wide Web, and said document is created with XML protocols.

13. The network method for providing verifications of claim 11 wherein:
said markup language document includes multiple content portions respectively from multiple sources on said network; and
said review verifications are provided from sources on said network independent of said sources of said markup language document.

14. The network method for providing verifications of claim 11 wherein at least one of said review verifications is a verified electronic signature.

15. A computer program having code recorded on a computer readable medium for providing verifications on a markup language document, from a source on a communication network with user access via a plurality of data processor controlled interactive network display stations, said computer program comprising:
means for reviewing said markup language document at a display station remote from said receiving display station;
means responsive to said reviewing means for providing review verifications for said reviewed markup language document;
means for selectively superimposing a transparent displayed layer over said displayed received markup language document; and
means for indicating said review verifications of said displayed markup language document by non-alphanumeric visual indicators within said transparent displayed layer.

16. The computer program for providing verifications of claim 14 wherein said visual indicators have specific colors.

17. The computer program for providing verifications of claim 15 further including means for modifying said visual indicators responsive to changes in said review verifications.

18. The network system for providing verifications of claim 4 wherein said network is the World Wide Web, and said document is created with XML protocols.

19. The computer program for providing verifications of claim 17 wherein:
said markup language document includes multiple content portions respectively from multiple sources on said network; and
said review verifications are provided from sources on said network independent of said sources of said markup language document.

20. The computer program for providing verifications of claim 17 wherein at least one of said review verifications is a verified electronic signature.
